(19) United States
(12) Patent Application Publication
(10) Pub. No.: US 2007/0262533 A1
(43) Pub. Date: Nov. 15, 2007

(54) SCRAPER RING

(76) Inventor: Wan-Chieh Lu, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/383,345

(22) Filed: May 15, 2006

(51) Int. Cl. F16J 9/00

(52) U.S. Cl. 277/434

(57) ABSTRACT

A scraper ring includes a ring body having a gap. The ring body includes an annular inner groove, an annular outer groove, a plurality of equally spaced apertures communicated with both the inner groove and the outer groove, and a pair of projected opposite side walls of the outer groove. The scraper ring includes a spring with an internal shaping member for maintaining a ring shape and with the ring spring being fitted in the inner groove. The spring is firmly disposed in the inner groove of the ring body by the flexibility of the ring body and the spring, improving the strength of the scraper ring. The scraper ring is thus able to stand the repeated movement of the piston inside the cylinder so as to increase its duration of use for a high performance engine.

### BACKGROUND OF THE INVENTION

1. Field of Invention

The present invention relates to piston rings and more particularly to a scraper ring with improved characteristics.

2. Related Art

Piston rings are classified as compression rings and scraper rings (i.e., oil rings). The scraper ring is adapted to scrape excess motor oil (i.e., lubricating oil) adhered to an inner surface of cylinder when an internal combustion engine (e.g., one installed in an automobile) is operating. Hence, a poor scraper ring may consume motor oil greatly and thus lower engine performance significantly.

However, typical scraper rings are disadvantageous due to high wear (i.e., not durable or short period of useful time). Hence, a need has arisen for an improved scraper ring without above drawback of the prior art.

### SUMMARY OF THE INVENTION

It is therefore an object of the present invention to provide a durable, high performance scraper ring comprising a ring body having a gap and comprising an annular inner groove, an annular outer groove, a plurality of equally spaced apertures communicated with both the inner groove and the outer groove, and a pair of projected opposite side walls of the outer groove; and a spring comprising an internal shaping member for maintaining a ring shape and the ring spring being fitted in the inner groove.

In another aspect of the present invention the ring body is processed by plating chromium or nano-ceramic material or nitrogenized thereon to decrease the friction, and an outer portion of the ring body is coating a diamond-like carbon layer thereon to protect the ring body from abrasion.

The above and other objects, features and advantages of the present invention will become apparent from the following detailed description taken with the accompanying drawings.

### BRIEF DESCRIPTION OF THE DRAWINGS

FIG. 1 is an exploded perspective view of a preferred embodiment of a scraper ring according to the invention;

FIG. 2 is a perspective view of the assembled scraper ring in FIG. 1;

FIG. 3 is a sectional view of the scraper ring in FIG. 2;

FIG. 4 is a detailed view of the area in circle A in FIG. 3;

FIG. 5 is a top sectional view of the scraper ring in FIG. 2; and

FIG. 6 is a view similar to FIG. 4 showing the diamond-like carbon layer of the scraper ring.

### DETAILED DESCRIPTION OF THE INVENTION

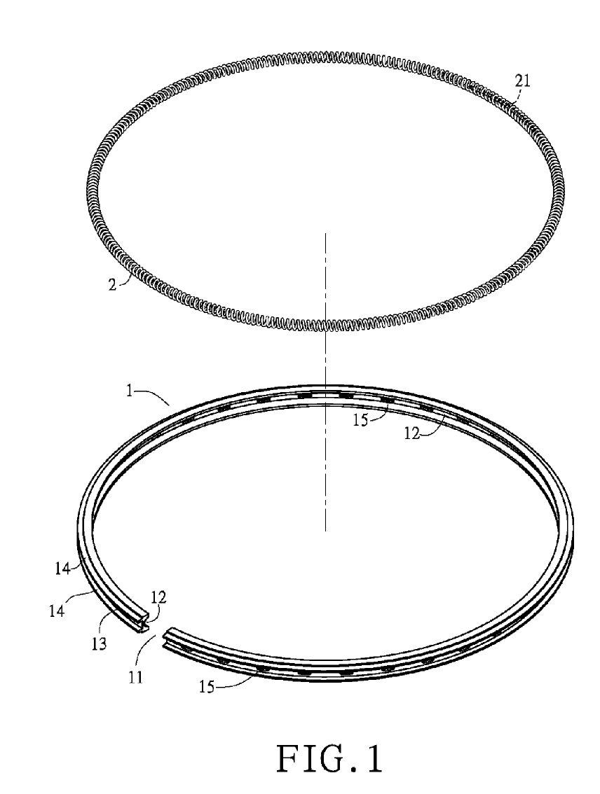

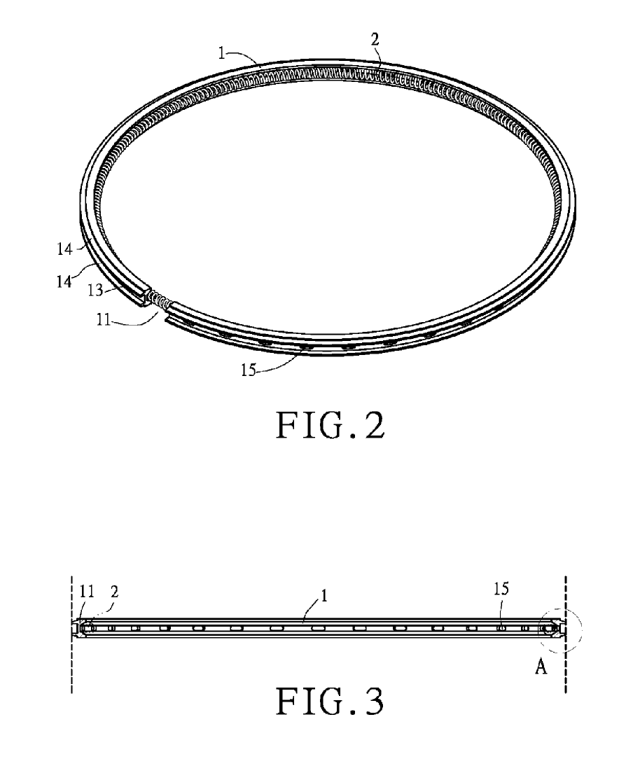

Referring to FIGS. 1-3, a scraper ring in accordance with a preferred embodiment of the invention comprises a C-shaped ring body 1 and a spring 2. Each component is discussed in detailed below.

The ring body 1 comprises a gap 11 such that the ring body 1 has flexibility. The ring body 1 has a substantially I-shaped cross-sectional shape and thus comprises an annular inner groove 12 inside having a cross-sectional shape that is substantially outwardly wider and an annular outer groove 13 outside having a pair of opposite projected side walls 14. A plurality of equally spaced apertures 15 are formed to communicate with both the inner groove 12 and the outer groove 13.

The spring 2 comprises an internal shaping member 21 for maintaining a ring shape of the spring 2. The ring spring 2 is fitted in the inner groove 12 to form a complete scraper ring.

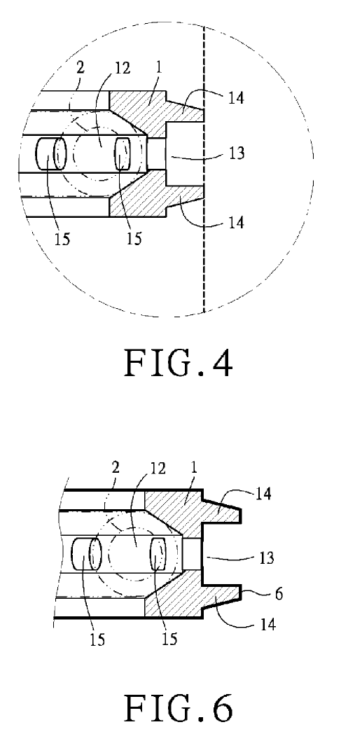

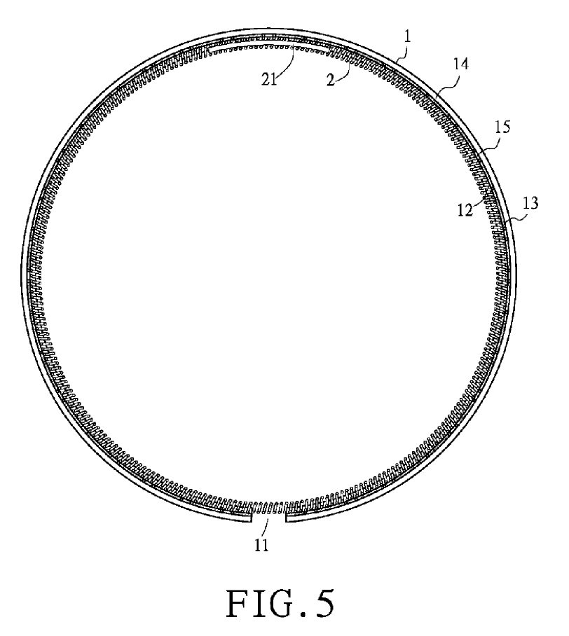

Preferably, the ring body 1 is processed by plating chromium or nano-ceramic material thereon, or nitrogenized. Also, as shown in FIG. 6, an outer portion of the ring body 1 is coating a diamond-like carbon layer thereon to prevent wear of the ring body 1. All of the above are designed to produce a scraper ring of low friction coefficient (i.e., low wear), lightweight, and durable (i.e., more robust). Moreover, as shown in FIG. 4, each of opposite side walls 14 of the outer groove 13 has a inclined outer side adapted to increase the efficiency of scraping excess motor oil adhered to an inner surface of cylinder when an internal combustion engine (e.g., one installed in an automobile) incorporating the scraper ring of the invention is operating, and form an oil film between the ring body 1 and an adjacent piston ring (not shown) to increase lubrication and sealing between an cylinder inner peripheral surface and the sliding surface of the piston ring. The scraped motor oil flows to the inner groove 12 through the apertures 15. Finally, the scraped motor oil drops into an oil pan (not shown) from the inner groove 12. Hence, a high performance engine is achieved.

As described above, the spring 2 is firmly disposed in the inner groove 12 of the ring body 1 by the flexibility of the ring body 1 and spring 2 and the strength of the scraper ring is improved. The scraper ring is thus able to stand the repeatedly movement of the piston inside the cylinder so as to increase its duration and achieve a high performance engine.

While the invention herein disclosed has been described by means of specific embodiments, numerous modifications and variations could be made thereto by those skilled in the art without departing from the scope and spirit of the invention set forth in the claims.

1: A scraper ring comprising:
a ring body having a gap, a top surface, and a bottom surface spaced from and parallel to the top surface, with the ring body having cross-sections extending through and transverse to the ton and bottom surface, with the ring body comprising an annular inner groove, with each of the cross-sections having a first side, a second side, a third side, a fourth side and a fifth side, with the first side generally perpendicular to the top surface and interconnected with the top surface and the second side, with the second side at an oblique angle to the first side and interconnected with the first side and the third side, with the third side generally parallel to and spaced from the first side and at a complementary angle to the second side and interconnected with the second side and the fourth side, with the fourth side spaced from the second side and at the complementary angle to the third side and interconnected with the third side and the fifth side, and with the fifth side generally perpendicular to the bottom surface and at the oblique angle to the fourth side and interconnected with the fourth side and the bottom surface, with the annular inner groove defined by the second side, the third side and the fourth side, with the ring body further comprising an annular outer groove spaced from the annular inner groove, and a plurality of equally spaced apertures communicated with both the inner groove and the outer groove, with each of the cross sections further having a first shoulder, a first inclined outer side, a first piston side, a first inner side, a second inner side, a second piston side, a second inclined outer side, a second shoulder, and a radial wall, with the first shoulder substantially perpendicular to the top surface and parallel and spaced from the first side and interconnected with the top surface and the first inclined outer side, with the first inclined outer side at a first oblique angle to the first shoulder and at a second oblique angle to the first piston side and interconnected with the first shoulder and the first piston side, with the first piston side substantially perpendicular to the top surface and parallel and spaced from the first side and interconnected with the first inclined outer side and the first inner side, with the first inner side substantially parallel to the top surface and interconnected with the first piston side and the radial wall, with the radial wall substantially perpendicular to the top surface and parallel and spaced from the third side and interconnected with the first inner side and the second inner side, with the second inner side substantially parallel to the top surface and interconnected with the radial wall and the second piston side, with the second piston side generally perpendicular to the top surface and parallel and spaced from the fifth side and interconnected with the second inclined outer side and the second inner side with the second inclined outer side at the second oblique angle to the second piston side and at the first oblique angle to the second shoulder and interconnected with the second piston side and the second shoulder, with the second shoulder substantially perpendicular to the bottom surface and parallel and spaced from the fifth side and interconnected with the second inclined outer side and the bottom surface, with the annular outer groove defined by the first inner side, the radial wall and the second inner side, and with chromium plating on the ring body; and
a spring comprising an internal shaping member for maintaining a ring shape, with the spring being fitted in the inner groove, with the spring being a radially expandable annular spring, with the spring having an outside annular radius transverse to a direction of expansion of the spring and an inside annular radius transverse to the direction of expansion of the spring, with the outside annular radius greater than the length of the radial wall, with the inside annular radius less than the length of the radial wall, with the spring spaced from the third side, and with the spring facially abutting the second side and the fourth side.

2-4. (canceled)

5: The scraper ring of claim 1, wherein the ring body is processed by plating has a nano-ceramic material formed directly thereon.

6: The scraper ring of claim 1, wherein the ring body has a nitrogenized layer formed directly thereon.

7: The scraper ring of claim 1, wherein an outer portion of the ring body has a coating of a diamond-like carbon layer directly thereon.
